(19) United States
(12) Patent Application Publication
(10) Pub. No.: US 2025/0385284 A1
(43) Pub. Date: Dec. 18, 2025

(54) FUEL CELL DURABILITY AND VALIDATION MODULE TEST STAND

(71) Applicant: GM Global Technology Operations LLC, Detroit, MI (US)

(72) Inventors: Samuel Shreeman, Royal Oak, MI (US); Daniel William Smith, Commerce, MI (US); Cristian Mirica, Rochester Hills, MI (US); David J. Hart-Predmore, Rochester, NY (US)

(73) Assignee: GM Global Technology Operations LLC, Detroit, MI (US)

(21) Appl. No.: 18/741,040

(22) Filed: Jun. 12, 2024

(51) Int. Cl. H01M 8/04537; H01M 8/04029; H01M 8/0432; H01M 8/0438; H01M 8/0444; H01M 8/04746; H01M 8/04828

(52) U.S. Cl. CPC H01M 8/04649; H01M 8/04029; H01M 8/0432; H01M 8/0438; H01M 8/0444; H01M 8/04753; H01M 8/04761; H01M 8/04843

(57) ABSTRACT

A test stand for a fuel cell module includes a power supply system, a fuel supply system, an exhaust system, and a cooling system. The power supply system includes a direct current (DC) generated from a fuel cell stack, the DC powering a load electrically connected to the fuel cell module, the fuel cell stack responsive to receiving a fuel and generating an exhaust. The fuel supply system includes a mass flow meter and provides the fuel from a remote fuel source, through at least one adjustable reservoir, to the fuel cell stack at an adjustable pressure. The exhaust system includes a collection device and is operable to receive the exhaust from the fuel cell stack. The cooling system is operable to circulate a coolant and includes a first heat exchanger and a second heat exchanger in parallel with one another.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a test stand that accommodates fuel cell durability testing and validation. When a fuel cell, such as a fuel cell configured to power a vehicle, is connected or equipped at a fuel cell test stand, the test stand allows a user to perform operational and durability testing on the fuel cell. For example, such tests allow the user to replicate operation of the fuel cell within a vehicle in an effort to validate functionality and obtain data related to performance of the fuel cell and associated components. Such testing also tests the durability of the fuel cell module before installation at the vehicle and, as such, identifies requisite changes or modifications to the fuel cell before installation. The ease of testing is increased when the fuel cell is equipped at a test stand compared to at a vehicle. Furthermore, if changes to the fuel cell are needed, the changes are often easier and more practical to implement before the fuel cell is installed in the vehicle.

While fuel cell test stands facilitate validation of a fuel cell before installation at a vehicle, fuel cell test stands generally occupy a large spatial footprint, which reduces the number of test stands that may be equipped in a testing area, such as a vehicle engineering laboratory. Further, the overall size of such stands limits the flexibility of the testing area layout within a laboratory. Further yet, fuel cell test stands typically have fixed configurations and, thus, may be unable to accommodate different testing parameters and/or different data acquisition methods.

### SUMMARY

One aspect of the disclosure provides a fuel cell module. The fuel cell module includes a power supply system, a fuel supply system, an exhaust system, and a cooling system. The power supply system includes a direct current (DC) generated from a fuel cell stack, the DC powering a load electrically connected to the fuel cell module, the fuel cell stack responsive to receiving a fuel and generating an exhaust. The fuel supply system is operable to provide the fuel from a remote fuel source, through at least one adjustable reservoir, to the fuel cell stack at an adjustable pressure and further including a mass flow measurement of the fuel provided to the fuel cell stack from a mass flow meter of the fuel supply system. The exhaust system is operable to receive the exhaust from the fuel cell stack, the exhaust system including a collection device that captures water from the exhaust. The cooling system is operable to circulate a coolant, the cooling system including a first heat exchanger and a second heat exchanger in parallel with one another and operable to draw heat from the coolant and away from the fuel cell module.

Implementations of the disclosure may include one or more of the following optional features. In some examples, the mass flow meter includes a first mass flow meter and a second mass flow meter, the first mass flow meter and the second mass flow meter disposed in parallel between the remote fuel source and the fuel cell stack.

In some further examples, when the fuel supply system operates to provide the fuel to the fuel cell stack at a first flow rate, the fuel flows from the remote fuel source through the first mass flow meter and not through the second mass flow meter and, when the fuel supply system operates to provide the fuel to the fuel cell stack at a second flow rate greater than the first flow rate, the fuel flows from the remote fuel source through the first mass flow meter and through the second mass flow meter.

In some other further examples, the first mass flow meter and the second mass flow meter include Coriolis mass flow meters.

In some implementations, the fuel supply system is operable to adjust a volume of the adjustable reservoir.

In some aspects, the collection device includes a steam separator that captures liquid water and steam from the exhaust.

In some configurations, the exhaust system includes a backpressure valve that is operable to adjust a level of backpressure experienced at the fuel cell stack.

In some examples, the exhaust system includes one or more sensors operable to detect at least one selected from the group consisting of (i) a hydrogen concentration of the exhaust, (ii) a temperature of the exhaust, and (iii) a pressure of the exhaust.

In some implementations, the fuel cell module further includes a control module operable to determine a high frequency resistance (HFR) of the fuel cell stack based on an alternating current (AC) applied to the fuel cell stack.

In some aspects, a test stand accommodates the power supply system, the fuel supply system, the exhaust system, and the cooling system.

Another aspect of the disclosure provides a testing system. The testing system includes a fuel cell stack, a power supply system, a fuel supply system, an exhaust system, a cooling system, and a control module. The fuel cell stack is operable to generate a direct current (DC) and an exhaust responsive to receiving a fuel, the DC powering a load electrically connected to the testing system. The power supply system includes the direct current (DC) generated from the fuel cell stack. The fuel supply system is operable to provide the fuel from a remote fuel source, through at least one adjustable reservoir, to the fuel cell stack at an adjustable pressure and further including a mass flow measurement of the fuel provided to the fuel cell stack from a mass flow meter of the fuel supply system. The exhaust system is operable to receive the exhaust from the fuel cell stack, the exhaust system including a collection device that captures water from the exhaust. The cooling system is operable to circulate a coolant, the cooling system including a first heat exchanger and a second heat exchanger in parallel with one another and operable to draw heat from the coolant and away from the testing system. The control module is operable to determine a high frequency resistance (HFR) of the fuel cell stack based on an alternating current (AC) applied to the fuel cell stack.

Implementations of this aspect of the disclosure may include one or more of the following optional features. In some examples, the mass flow meter includes a first mass flow meter and a second mass flow meter, the first mass flow meter and the second mass flow meter disposed in parallel between the remote fuel source and the fuel cell stack.

In some implementations, the fuel supply system is operable to adjust a volume of the adjustable reservoir.

In some aspects, the collection device includes a steam separator that captures liquid water and steam from the exhaust.

In some configurations, the exhaust system includes a backpressure valve that is operable to adjust a level of backpressure experienced at the fuel cell stack.

Yet another aspect of the disclosure provides a testing system. The testing system includes a first cabinet, a second cabinet, and a third cabinet. The first cabinet accommodates a power supply system, a fuel supply system, an exhaust system, and a cooling system. The power supply system includes a direct current (DC) generated from a fuel cell stack, the DC powering a load electrically connected to the fuel cell stack, the fuel cell stack responsive to receiving a fuel generating an exhaust. The fuel supply system is operable to provide the fuel from a remote fuel source, through at least one adjustable reservoir, to the fuel cell stack at an adjustable pressure and further including a mass flow measurement of the fuel provided to the fuel cell stack from a mass flow meter of the fuel supply system. The exhaust system is operable to receive the exhaust from the fuel cell stack, the exhaust system including a collection device that captures water from the exhaust. The cooling system is operable to circulate a coolant, the cooling system including a first heat exchanger and a second heat exchanger in parallel with one another and operable to draw heat from the coolant and away from the fuel cell stack. The second cabinet accommodates a DC electrical panel electrically operable to transfer power to the first cabinet and an alternating current (AC) electrical panel electrically operable to transfer power to the first cabinet. The third cabinet accommodates a control module operable to determine a high frequency resistance (HFR) of the fuel cell stack based on an AC load applied to the fuel cell stack.

Implementations of this aspect of the disclosure may include one or more of the following optional features. In some examples, the mass flow meter includes a first mass flow meter and a second mass flow meter, the first mass flow meter and the second mass flow meter disposed in parallel between the remote fuel source and the fuel cell stack.

In some implementations, the fuel supply system is operable to adjust a volume of the adjustable reservoir.

In some aspects, the collection device includes a steam separator that captures liquid water and steam from the exhaust.

In some configurations, the exhaust system includes a backpressure valve that is operable to adjust a level of backpressure experienced at the fuel cell stack.

### BRIEF DESCRIPTION OF THE DRAWINGS

The drawings described herein are for illustrative purposes only of selected configurations and are not intended to limit the scope of the present disclosure.

FIG. 1 is a perspective view of a fuel cell test stand.

FIG. 2 is a perspective view of the fuel cell test stand of FIG. 1 with a first cabinet removed to show a fuel cell module accommodated within the first cabinet.

FIG. 3 is a front view of an exhaust system of the fuel cell module.

FIG. 4 is a front view of a high-temp cooling circuit of the fuel cell module.

FIG. 5 is a front view of a charged-air cooling circuit of the fuel cell module.

FIG. 6 is a front view of a low-temp cooling circuit of the fuel cell module.

FIG. 7 is a schematic of the fuel, air, and nitrogen supply circuit of the fuel cell module.

FIG. 8 is a schematic of a control module of the fuel cell module.

FIG. 9 is a schematic of electrical connections between the fuel cell module and a load connected to the fuel cell test stand.

FIG. 10 is a schematic of a hydrogen concentration measurement system.

FIG. 11 is a schematic of the high-temp cooling circuit, the charged-air cooling circuit, and the low-temp cooling circuit.

FIG. 12 is a schematic of the exhaust system of the fuel cell module.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

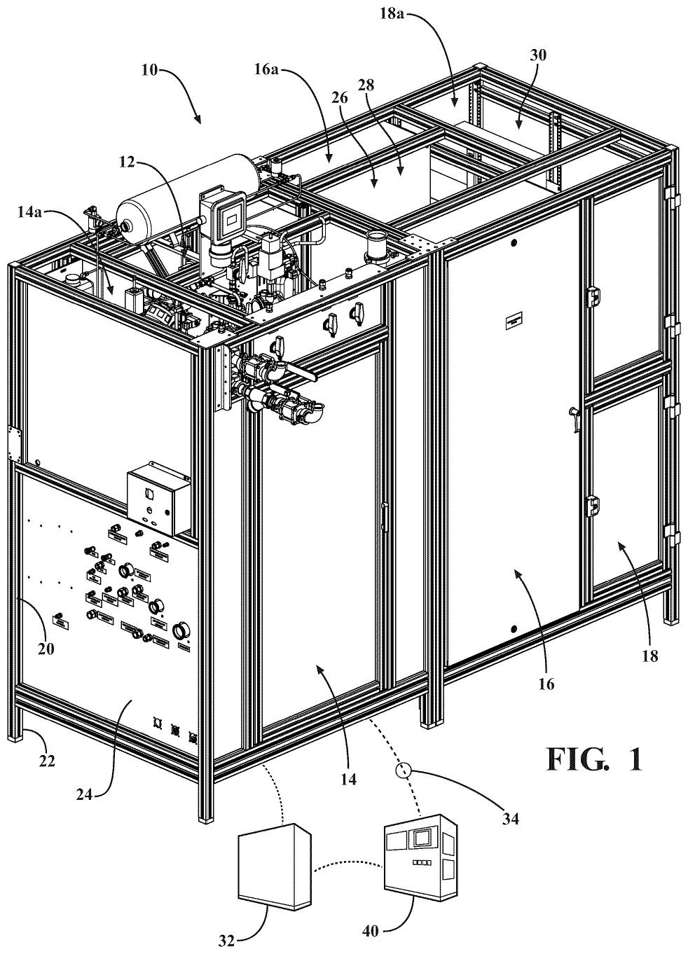

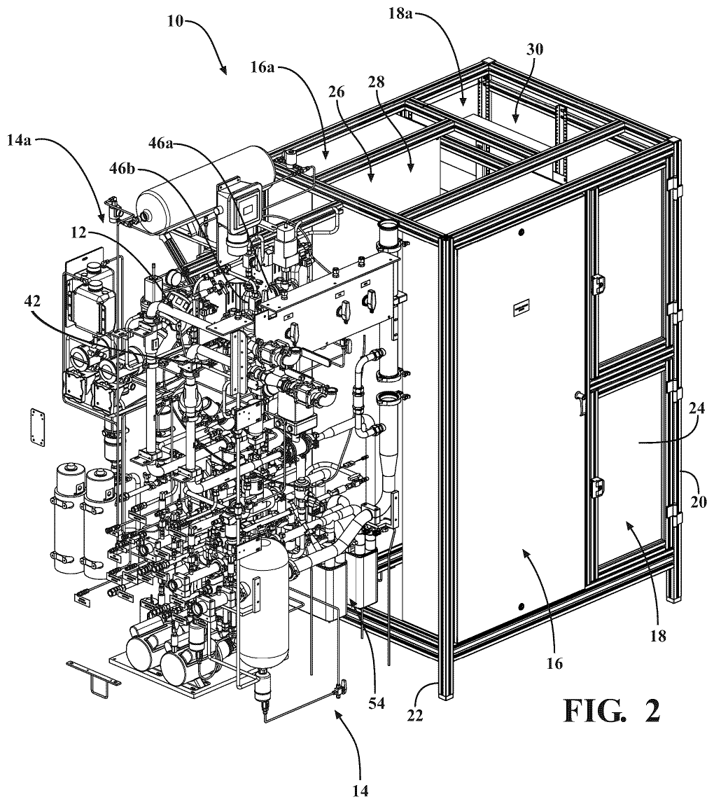

With reference to FIGS. 1 and 2, a fuel cell test stand or testing system 10 includes features of a fuel cell module 12 to allow a user to test and validate a fuel cell stack 32 connected to the fuel cell module 12. In this scenario, the fuel cell stack 32 is removed from a vehicle environment in which the fuel cell stack 32 is configured to be installed. In other words, the fuel cell test stand 10 includes components or subsystems of the fuel cell module 12 to provide fuel, exhaust, cooling, and control signals as the fuel cell stack 32 generates electrical power based on a load or load bank 40 connected to the fuel cell test stand 10. The fuel cell test stand 10 is configured to acquire data representative of the operation of the fuel cell stack 32 and fuel cell module 12 during testing. The tests accommodated by the testing system 10 may comprise any test required by a user of the testing system to properly validate and obtain data from the fuel cell module 12, such as durability testing, performance testing, longevity testing, among others. As discussed further below, the fuel cell test stand 10 and the features of the fuel cell module 12 are configured to provide a reduced footprint for the fuel cell test stand 10, allowing for greater flexibility in the testing environment. Furthermore, the fuel cell module 12 allows the user to adjust operating parameters of the fuel cell module 12, such as to simulate varying conditions experienced by the fuel cell stack 32.

The testing system 10 includes a first cabinet 14, a second cabinet 16, and a third cabinet 18 arranged in a side-by-side configuration as a single unit. Interior portions or compartments of the cabinets 14, 16, 18 may be at least partially bounded or partitioned from one another with ports, fluid conduits, electrical wiring, and other connections extending between the cabinets 14, 16, 18 for operating the testing system 10. Although the cabinets 14, 16, 18 are oriented in a side-by-side configuration, the specific sizing, orientation, configuration, and shape of the cabinets 14, 16, 18 may vary without deviating from the context of this disclosure.

The testing system 10 includes a frame 20 having a plurality of legs or footings 22 that support the cabinets 14, 16, 18 on the surface on which the testing system 10 is positioned, such as the floor in a vehicle engineering laboratory. Additionally, the frame 20 supports a plurality of panels 24 extending between respective members of the frame 20 that cooperate to define the respective cabinets 14, 16, 18 that enclose the testing system 10. The panels 24 also act to partition or bound the interior portions or compartments of the individual cabinets 14, 16, 18 from one another, with openings, ports, or through-holes extending through the panels 24 to provide interaction between components included in separate cabinets 14, 16, 18 via piping, wiring, and the like. Both the frame 20 and the panels 24 may act as mounting surfaces for the components included in the testing system 10.

For example, and as described further below, the first cabinet 14 may define a first compartment 14a that accommodates the fuel cell module 12 and contains mechanical components associated with operating the fuel cell stack 32. The second cabinet 16 may define a second compartment 16a that accommodates one or more electrical panels (e.g., for providing power to components within the fuel cell module 12), such as a DC electrical panel 26 and an AC electrical panel 28. The third cabinet 18 may define a third compartment 18a that accommodates a control module 30 configured to control operation of the testing system 10.

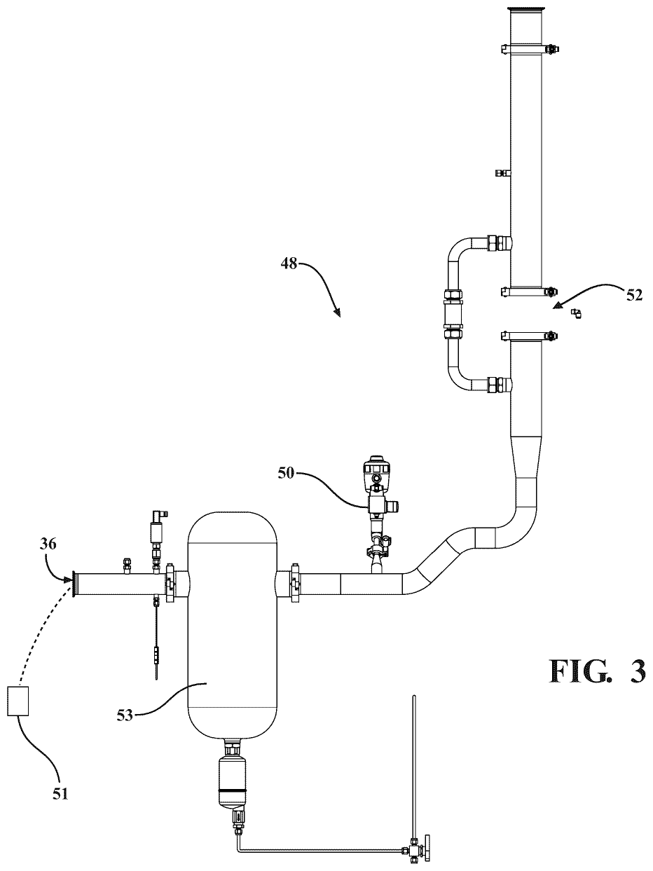

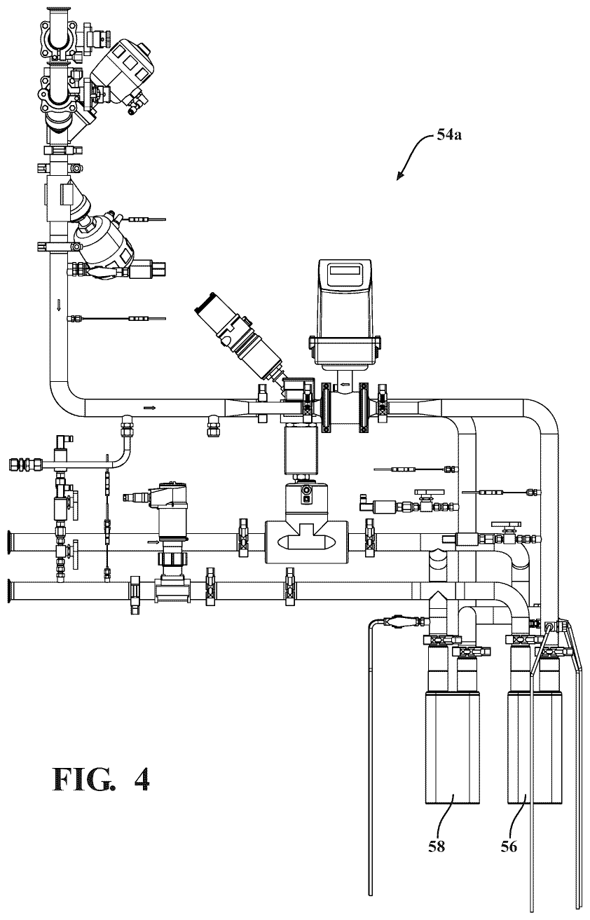

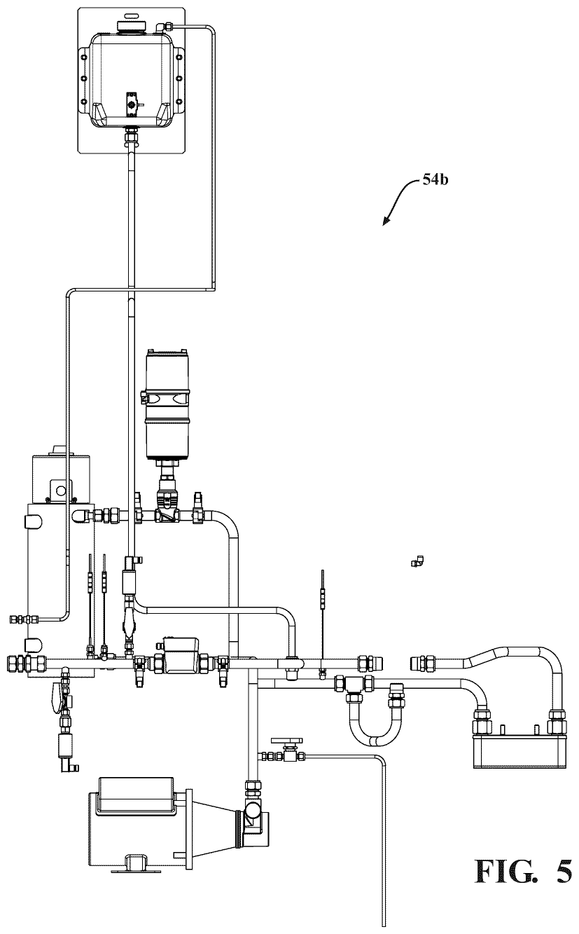

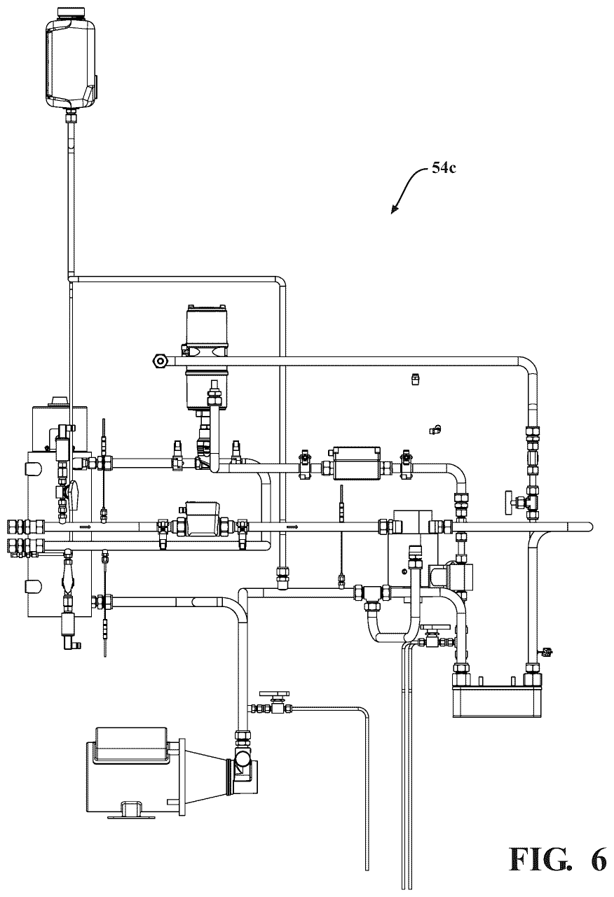

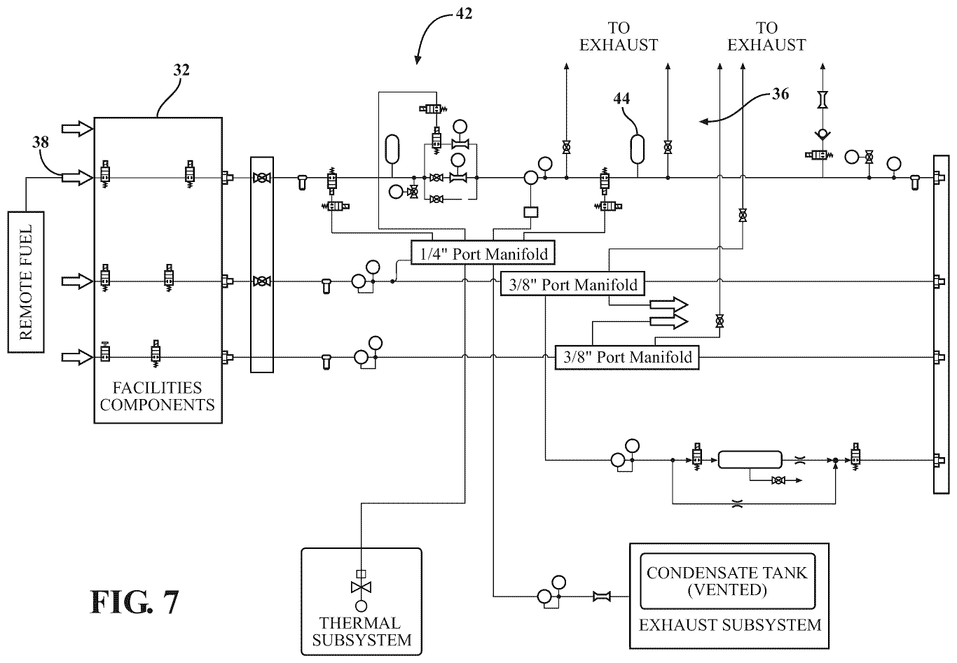

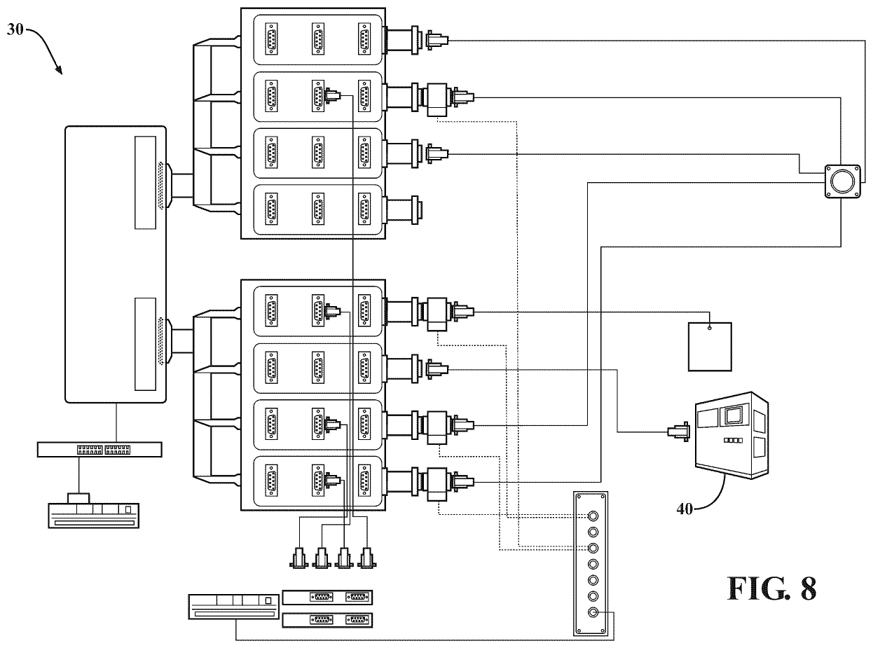

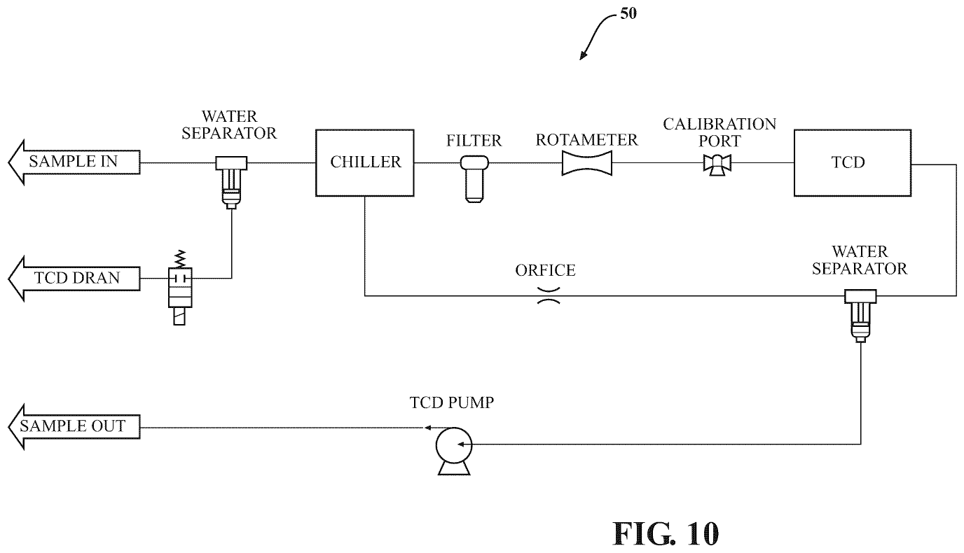

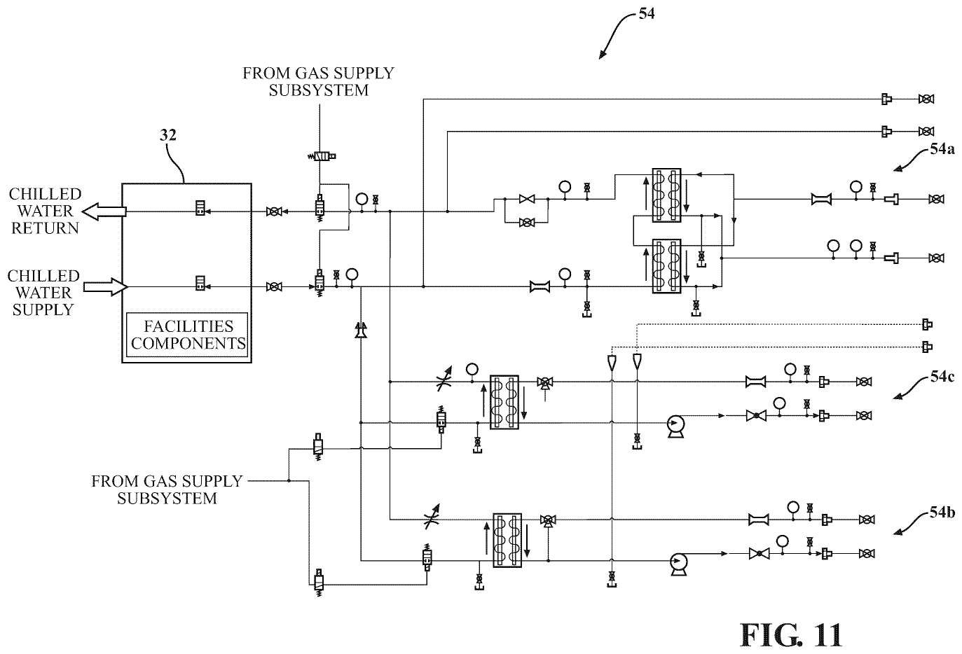

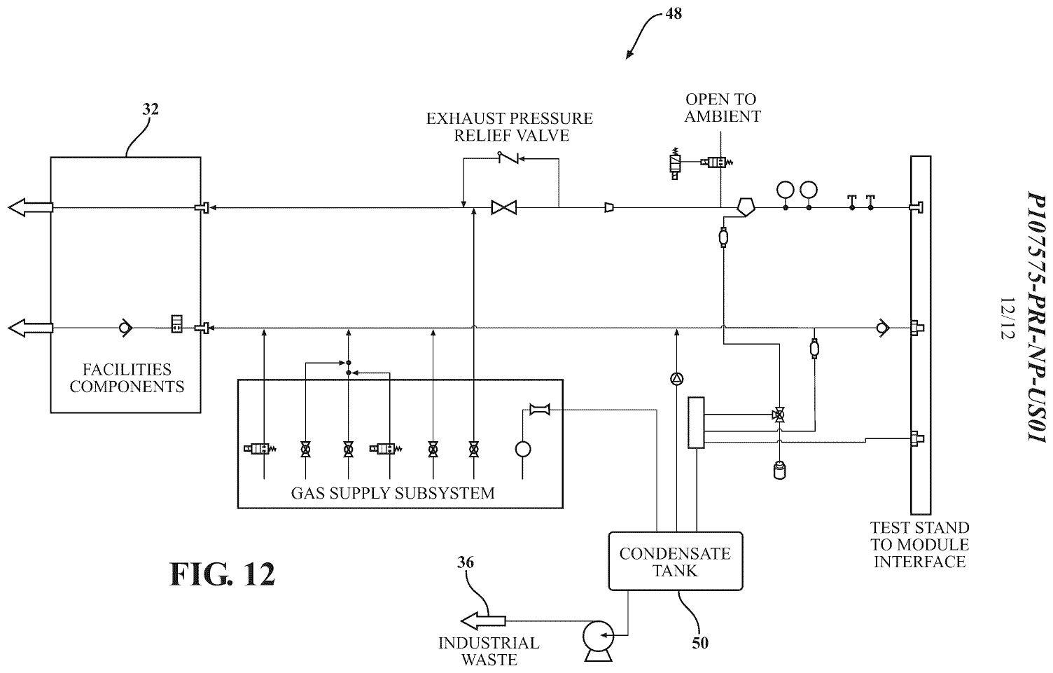

With continued reference of FIGS. 1 and 2, and also with reference to FIGS. 3-12, the fuel cell module 12 includes a variety of components and subsystems positioned within the first cabinet 14 of the testing system 10, where the layout, configuration, and/or orientation of the components and subsystems contributes to the compact nature and minimal footprint of the testing system 10. In the illustrated example, the fuel cell module 12 is remote from the fuel cell stack 32, the fuel cell stack 32 operable to generate a direct current (DC) output 34 and an exhaust 36 (e.g. air, liquid water, and/or steam) responsive to receiving a fuel 38, such as hydrogen. The load bank 40 demands the DC output 34 of the fuel cell stack 32, both the load bank 40 and the fuel cell stack 32 electrically connected to the fuel cell module 12 via a power supply system. As shown, the load bank 40 interacts with the fuel cell module 12 via a hard-wired connection, and the load bank 40 itself is remote from the cabinets 14, 16, 18 and can be positioned at any location that is convenient in the testing environment, so long as the connection between the load bank 40 and the fuel cell module 12 is accommodated. Thus, the load bank 40 may be adjusted or swapped based on the testing needs of the system 10.

Furthermore, the load bank 40 is bi-directional, meaning it is controlled through specialized contactors to allow for powering the fuel cell module 12 as well as creating a load on the fuel cell module 12. The bi-directional nature of the load bank 40 creates a more realistic testing system 10 that closely resembles a real-world scenario of a vehicle powered by a fuel cell. As the fuel cell stack 32 generates the DC output 34 that is transferred to the load bank 40, the load bank 40 may measure the DC output 34 of the fuel cell stack 32 for testing and analysis purposes.

The fuel cell module 12 also includes a fuel supply system 42 operable to facilitate the transportation of the fuel 38 from a remote fuel source, through at least one adjustable reservoir 44, to the fuel cell stack 32 and the fuel cell module 12 at an adjustable pressure. For example, the pressure of the fuel 38 provided to the fuel cell stack 32 may be adjusted based on the load bank 40 and operating parameters of the fuel cell stack 32. Flow of the supplied fuel 38 may be read by a first mass flow meter 46a and a second mass flow meter 46b of the fuel supply system 42 for controlling the fuel supply. The two mass flow meters 46a, 46b monitor a mass flow measurement of the fuel 38 to allow the user and/or control module 30 of the testing system 10 to obtain fuel flow data and adjust the flow of fuel 38.

In the illustrated example, the mass flow meters 46a, 46b include Coriolis-style mass flow meters. Coriolis-style mass flow meters may be relatively small in size and thus contribute to the small footprint of the testing system 10. Further, because Coriolis-style mass flow meters 46a, 46b measure mass flow rather than volumetric flow, and do not require laminar flow, the plumbing that feeds into the mass flow meters 46a, 46b may be bent, curved, or contoured to accommodate other components of the testing system 10. In other words, the plumbing at respective inlets of the mass flow meters 46a, 46b may be bent or angled, which helps to reduce the space requirements of the fuel cell module 12.

Furthermore, the mass flow meters 46a, 46b are arranged in parallel to one another within the fuel cell module 12. Accordingly, the first mass flow meter 46a may provide the mass flow measurement when the fuel supply system 42 is operating within a first range of flow rates and the second mass flow meter 46b may provide the mass flow measurement when the fuel supply system is operating within a second range of flow rates. The first range of flow rates and the second range of flow rates may at least partially overlap with the second range of flow rates including higher flow rates than the first range of flow rates. For example, when the fuel supply system 42 operates at a first, lower flow rate, the fuel 38 flows through the first mass flow meter 46a to the fuel cell stack 32, and the fuel 38 does not pass through the second mass flow meter 46b. When the fuel supply system 42 operates at a second, higher flow rate, the fuel 38 flows to the fuel cell stack 32 through both the first mass flow meter 46a and the second mass flow meter 46b. The use of two mass flow meters 46a, 46b allows for greater reliability in the accuracy of fuel flow rate readings at both higher flow rates and lower flow rates, creating a more robust and accurate testing system 10. Thus, the flow rate of the supplied fuel 38 may be adjusted based on the mass flow measurement of the fuel 38 provided to the fuel cell stack 32 from at least one of the first mass flow meter 46a and the second mass flow meter 46b.

In some examples, the fuel supply system 42 may be operable to adjust a volume of the adjustable reservoir 44, an available volume of the adjustable reservoir 44, and/or a volume of fuel 38 supplied from the adjustable reservoir 44, via the remote fuel source, at one time. For example, the fuel supply system 42 may include a series of valves between the fuel cell stack 32 and the adjustable reservoir. Activating or opening and deactivating or closing different valves may adjust the volume of fuel 38 available to the fuel cell module 12 to simulate different installation scenarios for the fuel cell stack 32.

Furthermore, the fuel cell module 12 includes an exhaust system 48 that operates to receive the exhaust 36 from the fuel cell stack 32 during its operation. The exhaust system 48 includes a collection device or water knockout device or steam separator 50 that captures water and/or steam from the exhaust 36 during operation of the fuel cell module 12. When the exhaust 36 flows into or through the collection device 50, the collection device 50 captures one or both of liquid water and steam for the purposes of analysis. For example, the collection device 50 may include a steam line that delivers steam from the exhaust 36 to a condenser 53, such that the steam condenses to liquid water and may be analyzed. The collection device 50 may further include a water line that delivers water from the exhaust 36 and/or the condenser 53 to a sensor or testing device for analysis. Analysis of water collected at the collection device 50 may determine the health of the fuel cell stack 32. For example, the collected water may indicate whether the fuel cell stack 32 has experienced a higher or lower level of anticipated degradation after a usage period of the testing system 10.

The exhaust system 48 further includes a backpressure valve 52 operable to induce different levels of backpressure onto the fuel cell module 12 through the exhaust system 48 for purposes of simulating real-world scenarios in vehicles fitted with a fuel cell. By way of example, the backpressure valve 52 may operate to apply increased pressure at the fuel cell stack 32 to configure the testing system 10 to be as accurate of a representation of fuel cell applications included in vehicles. In doing so, operation of the fuel cell module 12 may react and produce different test results based on levels of backpressure applied via operation of the backpressure valve 52. The backpressure valve 52 does not produce pressure but, rather, allows for pressure to build up in the exhaust system 48.

The exhaust system 48 further includes instrumentation for measuring hydrogen concentration, temperature, and/or pressure of the exhaust 36 created from the fuel cell stack 32. That is, the exhaust system 48 includes a sensor 51 that is operable to detect one or more characteristics of the exhaust 36, such as based on the water collected by the collection device 50 or based on exhaust 36 exiting the exhaust system 48. For example, the sensor 51 is operable to detect the hydrogen concentration of the exhaust 36, the temperature of the exhaust 36, and/or the pressure of the exhaust 36.

The fuel cell module 12 also includes a cooling system 54 operable to circulate coolant throughout the fuel cell module 12. The cooling system 54 operates to control temperature of one or more components of the fuel cell module 12. As configured in the first cabinet 14, the cooling system 54 is positioned vertically below the fuel supply system 42, allowing for a reduced footprint for both the cooling system 54 and the fuel supply system 42 and, thus, a reduced footprint for the testing system 10. In the illustrated example, the cooling system 54 includes a high-temp cooling circuit 54a, a charged-air cooling circuit 54b, and a low-temp cooling circuit 54c. The charged-air cooling circuit 54b and the low-temp cooling circuit 54c are operable to circulate coolant to portions or subsystems of the fuel cell module 12 that operate at lower temperatures and thus do not require a significant amount of cooling, such as minor electronics and small circuits and the like. The high-temp cooling circuit 54a is operable to circulate coolant to portions or subsystems of the fuel cell module 12 that operate at higher temperatures and thus require greater cooling. Additionally, the high-temp cooling circuit 54a provides cooling to the fuel cell stack 32, remote from the fuel cell module 12.

The high-temp cooling circuit 54a includes a first heat exchanger 56 and a second heat exchanger 58 that are in parallel with one another along the high-temp cooling circuit 54a and that operate to draw heat away from the coolant and away from the components within the fuel cell module 12. Compared to a single heat exchanger large enough to provide cooling equal to that of the parallel heat exchangers, the use of the parallel first heat exchanger 56 and second heat exchanger 58 in the fuel cell module 12 reduces the footprint of the cooling system 54, and thus the testing system 10, while still providing sufficient cooling capabilities to properly operate the testing system 10.

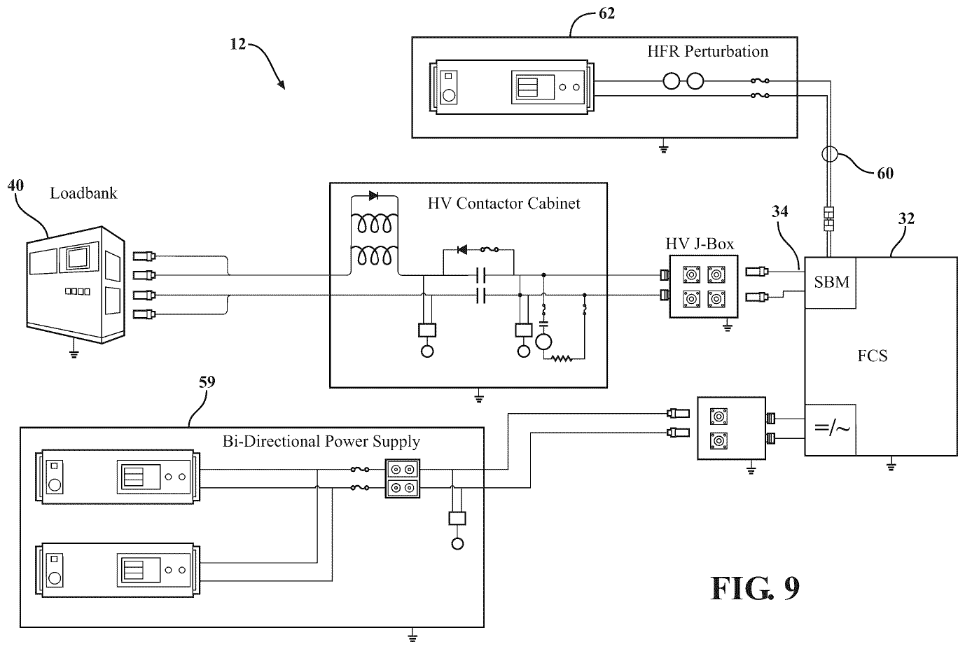

Referring to FIGS. 2 and 9, the second cabinet 16 accommodates the DC electrical panel 26 and the AC electrical panel 28. The DC electrical panel 26 is electrically connected to the fuel cell module 12 that is positioned in the first cabinet 14, operable to provide power to components within the fuel cell module 12, such as various sensors and valves. The power provided from the DC electrical panel 26 is separate from the DC output 34 generated by the fuel cell stack 32. Regarding the AC electrical panel 28, a bi-directional power supply 59 provides power to the AC electrical panel 28 to distribute power to various components within the fuel cell module 12, similar to the function of the DC electrical panel 26. The power provided to the fuel cell module 12 via the AC electrical panel 28 is separate from an alternating current (AC) load 60 received by the fuel cell stack 32 to simulate electrical load on the fuel cell module 12, which may simulate real-world scenarios on the testing system 10 and will be explained in greater detail below. Additionally, the AC electrical panel 28 is able to modulate the amount power applied to the fuel cell module 12, the settings of which may be configured by the user of the testing system 10.

The third cabinet 18 accommodates the control module 30 of the testing system 10. The control module 30 may include processing circuitry and associated software operable to configure a high frequency resistance (HFR) unit 62 to provide the AC load 60 to the fuel cell stack 32, both the HFR unit 62 and the bi-directional power supply 59 contained in the third cabinet 18. In other words, the control module 30 allows the user to both operate and obtain data from the fuel cell module 12, and specifically, to control operations related to AC load 60 provided by the HFR unit 62 and obtain data related to the HFR unit 62, the fuel cell stack 32, and the fuel cell module 12 as a result of the applied AC load 60 onto the fuel cell stack 32. The data obtained related to the HFR unit 62 may include performance and lifecycle of the fuel cell module 12 and the fuel cell stack 32. Aside from obtaining data related to the HFR unit 62, the control module 30 may include additional software for operational and recording purposes. As an example, software may be included to analyze the safety of the testing system 10 as well as input/output management. High voltage power to and from the fuel cell module 12, as well as local hydrogen levels, are monitored by the control module 30 to maintain a sufficient level of safety for the user. To monitor these readings, the control module 30 allows for various levels of access to the fuel cell module 12 even when the product is operating, such as, for example, during troubleshooting scenarios. Input/output management allows the user to acquire data related to flow measurements, pressures, temperatures, and conductivity, among other pieces of data, related to various applicable components of the testing system 10. The control module 30 allows for any acquired data to be collected, read, and stored during operation of the testing system 10 for the purposes of product development and validation. Further, the control module 30 is responsible for facilitating specific validation tests as desired by the user. In other words, the user is able to configure the control module 30 to run a specific test, read and acquire data obtained as a result of the test, and analyze the data as desired. Any software used within the control module 30 is specifically configured for the testing system 10 in which the control module 30 is installed.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fuel cell module comprising:
a power supply system including a direct current (DC) generated from a fuel cell stack, the DC powering a load electrically connected to the fuel cell module, the fuel cell stack responsive to receiving a fuel and generating an exhaust;
a fuel supply system operable to provide the fuel from a remote fuel source, through at least one adjustable reservoir, to the fuel cell stack at an adjustable pressure and further including a mass flow measurement of the fuel provided to the fuel cell stack from a mass flow meter of the fuel supply system;
an exhaust system operable to receive the exhaust from the fuel cell stack, the exhaust system comprising a collection device that captures water from the exhaust; and
a cooling system operable to circulate a coolant, the cooling system comprising a first heat exchanger and a second heat exchanger in parallel with one another and operable to draw heat from the coolant and away from the fuel cell module.

2. The fuel cell module of claim 1, wherein the mass flow meter comprises a first mass flow meter and a second mass flow meter, the first mass flow meter and the second mass flow meter disposed in parallel between the remote fuel source and the fuel cell stack.

3. The fuel cell module of claim 2, wherein, when the fuel supply system operates to provide the fuel to the fuel cell stack at a first flow rate, the fuel flows from the remote fuel source through the first mass flow meter and not through the second mass flow meter and, when the fuel supply system operates to provide the fuel to the fuel cell stack at a second flow rate greater than the first flow rate, the fuel flows from the remote fuel source through the first mass flow meter and through the second mass flow meter.

4. The fuel cell module of claim 2, wherein the first mass flow meter and the second mass flow meter comprise Coriolis mass flow meters.

5. The fuel cell module of claim 1, wherein the fuel supply system is operable to adjust a volume of the adjustable reservoir.

6. The fuel cell module of claim 1, wherein the collection device comprises a steam separator that captures liquid water and steam from the exhaust.

7. The fuel cell module of claim 1, wherein the exhaust system comprises a backpressure valve that is operable to adjust a level of backpressure experienced at the fuel cell stack.

8. The fuel cell module of claim 1, wherein the exhaust system comprises one or more sensors operable to detect at least one selected from the group consisting of (i) a hydrogen concentration of the exhaust, (ii) a temperature of the exhaust, and (iii) a pressure of the exhaust.

9. The fuel cell module of claim 1, further comprising a control module operable to determine a high frequency resistance (HFR) of the fuel cell stack based on an alternating current (AC) applied to the fuel cell stack.

10. The fuel cell module of claim 1, wherein a test stand accommodates the power supply system, the fuel supply system, the exhaust system, and the cooling system.

11. A testing system comprising:
a fuel cell stack operable to generate a direct current (DC) and an exhaust responsive to receiving a fuel, the DC powering a load electrically connected to the testing system;
a power supply system including the direct current (DC) generated from the fuel cell stack;
a fuel supply system operable to provide the fuel from a remote fuel source, through at least one adjustable reservoir, to the fuel cell stack at an adjustable pressure and further including a mass flow measurement of the fuel provided to the fuel cell stack from a mass flow meter of the fuel supply system;
an exhaust system operable to receive the exhaust from the fuel cell stack, the exhaust system comprising a collection device that captures water from the exhaust;
a cooling system operable to circulate a coolant, the cooling system comprising a first heat exchanger and a second heat exchanger in parallel with one another and operable to draw heat from the coolant and away from the testing system; and
a control module operable to determine a high frequency resistance (HFR) of the fuel cell stack based on an alternating current (AC) applied to the fuel cell stack.

12. The testing system of claim 11, wherein the mass flow meter comprises a first mass flow meter and a second mass flow meter, the first mass flow meter and the second mass flow meter disposed in parallel between the remote fuel source and the fuel cell stack.

13. The testing system of claim 11, wherein the fuel supply system is operable to adjust a volume of the adjustable reservoir.

14. The testing system of claim 11, wherein the collection device comprises a steam separator that captures liquid water and steam from the exhaust.

15. The testing system of claim 11, wherein the exhaust system comprises a backpressure valve that is operable to adjust a level of backpressure experienced at the fuel cell stack.

16. A testing system comprising:
a first cabinet accommodating:
a power supply system including a direct current (DC) generated from a fuel cell stack, the DC powering a load electrically connected to the fuel cell stack, the fuel cell stack responsive to receiving a fuel and generating an exhaust;
a fuel supply system operable to provide the fuel from a remote fuel source, through at least one adjustable reservoir, to the fuel cell stack at an adjustable pressure and further including a mass flow measurement of the fuel provided to the fuel cell stack from a mass flow meter of the fuel supply system;
an exhaust system operable to receive the exhaust from the fuel cell stack, the exhaust system comprising a collection device that captures water from the exhaust; and
a cooling system operable to circulate a coolant, the cooling system comprising a first heat exchanger and a second heat exchanger in parallel with one another and operable to draw heat from the coolant and away from the fuel cell stack;
a second cabinet accommodating:
a DC electrical panel electrically operable to transfer power to the first cabinet; and
an alternating current (AC) electrical panel electrically operable to transfer power to the first cabinet; and
a third cabinet accommodating:
a control module operable to determine a high frequency resistance (HFR) of the fuel cell stack based on an AC load applied to the fuel cell stack.

17. The testing system of claim 16, wherein the mass flow meter comprises a first mass flow meter and a second mass flow meter, the first mass flow meter and the second mass flow meter disposed in parallel between the remote fuel source and the fuel cell stack.

18. The testing system of claim 16, wherein the fuel supply system is operable to adjust a volume of the adjustable reservoir.

19. The testing system of claim 16, wherein the collection device comprises a steam separator that captures liquid water and steam from the exhaust.

20. The testing system of claim 16, wherein the exhaust system comprises a backpressure valve that is operable to adjust a level of backpressure experienced at the fuel cell stack.
